(19) United States
(12) Patent Application Publication
(10) Pub. No.: US 2014/0129391 A1
(43) Pub. Date: May 8, 2014

(54) DELIVERY GROUP DETERMINATION USING SOURCING AND AVAILABILITY

(71) Applicant: SAP AG, Walldorf (DE)

(72) Inventors: Carsten Kreuels, Contwig (DE); Thomas Kern, Wiesloch (DE); Adam Stollarski, Reilingen (DE)

(73) Assignee: SAP AG, Walldorf (DE)

(21) Appl. No.: 13/672,397

(22) Filed: Nov. 8, 2012

(51) Int. Cl. G06Q 30/00

(52) U.S. Cl. 705/26.81

(57) ABSTRACT

Techniques and tools are described for delivery group management through determination of delivery alternatives. Order items requested for delivery are combined into delivery groups based on fixed constraints as well as sourcing and availability information. Delivery groups are combined into delivery alternatives. Availability determinations consider multiple sourcing possibilities for the order items. Delivery alternatives can be displayed as part of a user interface to facilitate selection by a user. Delivery alternatives can be useful for selecting cost efficient or otherwise optimized deliveries.

### BACKGROUND

When ordering goods, a customer typically wants to know whether the requested quantity of goods is available, in how many deliveries the goods will arrive, what the delivery costs will be, when the goods are available to be delivered, where the goods will come from, and what goods will be delivered together. Also, the seller who receives the order for the goods from the customer is interested in using this information to optimize the deliveries, to control his own delivery costs and to satisfy his customers. The answers to these questions depend on how the goods are grouped for delivery. For example, a customer may want to group items to be delivered together, such as to reduce shipping costs. However, grouping items into a single shipment can cause delays if items within the group are available at different times.

Conventional ordering systems designate groups for the ordered items based on the customer's (e.g. a sales representative's or clerk's) grouping of the items into a single order, or other grouping manually performed by the seller based on company policies or customer wishes. Often, these grouping decisions are made without sufficient information on which to base the groupings. Alternatively, the information provided may be overwhelming, such as complicated charts listing availability dates and quantities for all ordered items, making it nearly impossible to manually select the most cost efficient or time efficient manner of grouping items to be delivered.

There is still a need to address the difficulties of grouping items for delivery in an efficient, customer-friendly, and flexible manner.

### SUMMARY

Techniques and tools are described for delivery group management through determination of delivery groups and combining of the delivery groups into delivery alternatives. Order items requested for delivery are combined into delivery groups based on fixed constraints as well as sourcing and availability information. Availability determinations consider multiple sourcing possibilities for the order items. Delivery groups and/or delivery alternatives can be displayed as part of a user interface to facilitate selection by a user.

Delivery alternative can be useful for selecting cost efficient or otherwise optimized delivery group(s).

The foregoing and other features and advantages will become more apparent from the following detailed description of disclosed embodiments, which proceeds with reference to the accompanying drawings.

### BRIEF DESCRIPTION OF THE DRAWINGS

FIG. 1 is a block diagram of an exemplary system implementing the delivery group management technologies described herein.

FIG. 2 is a flowchart of an exemplary method of implementing the delivery group management technologies described herein.

FIG. 3 is a block diagram of an exemplary system implementing the delivery group management technologies described herein.

FIG. 4 is a block diagram of an exemplary system implementing the delivery group management technologies described herein using a network.

FIG. 5 is a flowchart of an exemplary method of building delivery alternatives.

FIG. 6 is a flowchart of an exemplary method of determining availability using sourcing information.

FIG. 7 is a flowchart of an exemplary method of implementing the delivery group management technologies described herein.

FIG. 8 is an illustration of an exemplary user interface including a request for delivery.

FIG. 9 is an illustration of an exemplary user interface displaying delivery alternatives.

FIG. 10 is an illustration of an exemplary user interface displaying delivery alternatives.

FIG. 11 is an illustration of an exemplary user interface displaying delivery alternatives.

FIG. 12 is a diagram of an exemplary computing environment suitable for implementing any of the technologies described herein.

FIG. 13 is an exemplary cloud computing environment that can be used in conjunction with the technologies described herein.

### DETAILED DESCRIPTION

### Example 1

### Exemplary Overview

The technologies described herein can be used for a variety of delivery group management scenarios. Adoption of the technologies can provide a convenient and efficient technique for determining delivery groups using sourcing and availability information, such as by providing delivery alternatives to a user for selection.

The technologies can be helpful to those wishing to improve control over delivery of ordered items, such as over cost and timing of delivery. Beneficiaries include any business that orders items from one location for delivery to another. Customers, such as sales representatives, can also greatly benefit from the technologies because, by offering delivery alternatives, the technologies make it easier to group items for delivery in a manner that reduces cost or complies with internal shipping or delivery policies.

### Example 2

### Exemplary System Employing a Combination of the Technologies

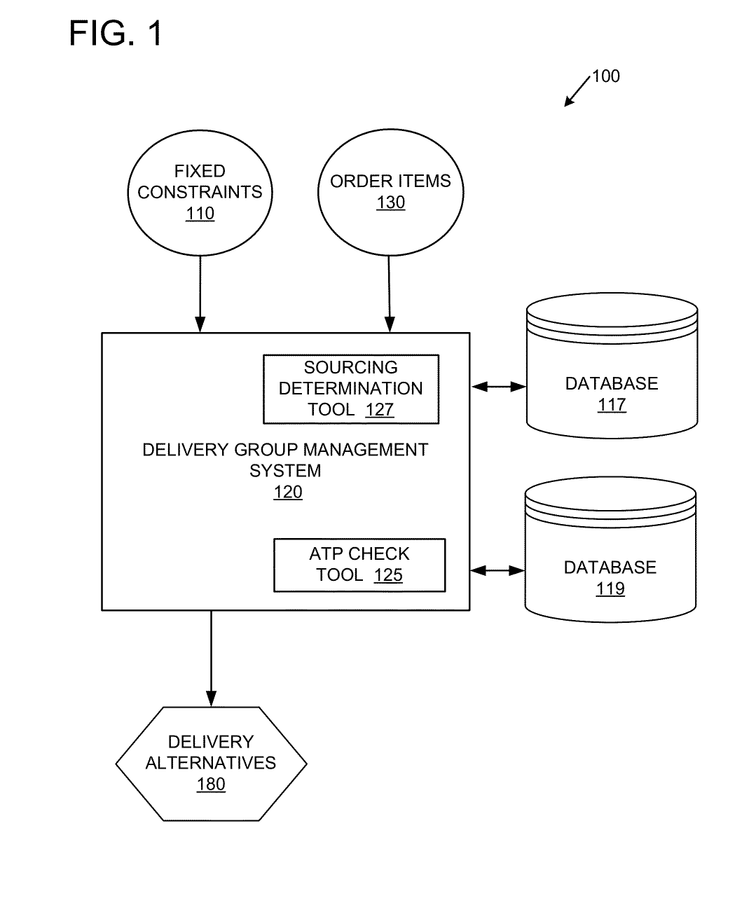

FIG. 1 is a block diagram of an exemplary system 100 for implementing the delivery group management technologies described herein. In the example, one or more computers in a computing environment implement a delivery group management system 120.

The delivery group management system 120 receives as input order items 130 and fixed constraints 110 and generates delivery alternatives 180. As described herein, the delivery group management system can include a sourcing determination tool 127 and an availability check (e.g., available-to-promise (ATP) check) tool 125. In some examples, the delivery management system can also include a cost calculation engine (not shown).

The sourcing determination tool 127 can function by consulting a database 117. Likewise, the ATP check tool 125 can function by consulting a database 119. The databases 117, 119 can be integrated into the delivery group management system, or the databases can be part of one or more separate computers or computing environments. For example, communication with the database 117 and/or the database 119 can be via a network (e.g., the Internet).

In practice, the systems shown herein, such as system 100 can be more complicated, with additional functionality, more complex inputs, and the like.

In any of the examples herein, the inputs, outputs, and tools can be stored in one or more computer-readable storage media or computer-readable storage devices.

### Example 3

### Exemplary Method of Applying a Combination on the Technologies

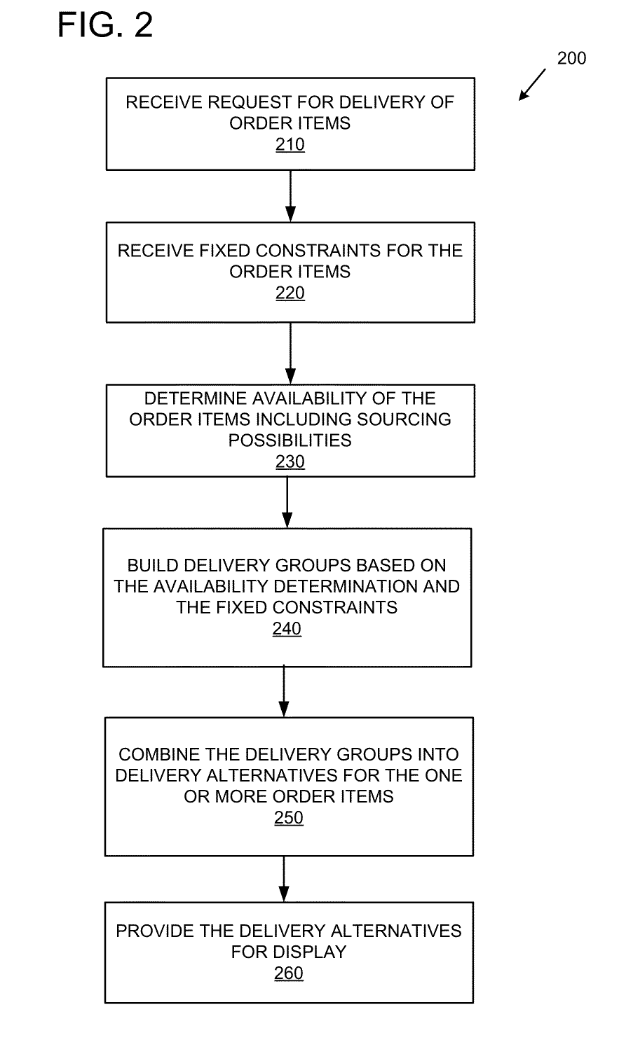

FIG. 2 is a flowchart of an exemplary method 200 of implementing the delivery group management technologies described herein and can be implemented, for example, in a system such as that shown in FIG. 1. The technologies described herein can be generic to the specifics of operating systems or hardware and can be applied in any variety of environments to take advantage of the described features.

At 210, a request for delivery of one or more order items is received. The request can be input by a user, such as via a website or otherwise transmitted from the user's computer. At 220, fixed constraints for the order items are received.

At 230, the availability of the order items is determined. As described herein, this availability determination includes determining availability for multiple sourcing possibilities of the order items. At 240, delivery groups are built based on the availability determination and the fixed constraints. At 250, the delivery groups are combined into delivery alternatives for the one or more order items. Each delivery alternative includes one or more of the delivery groups, and each delivery alternative can provide for the delivery of all of the order items. At 260, the delivery alternatives are provided for display to a user as part of a user interface.

The method 200 and any of the methods described herein can be performed by computer-executable instructions stored in one or more computer-readable media (e.g., storage or other tangible media) or stored in one or more computer-readable storage devices.

### Example 4

### Exemplary Order Items

In any of the examples herein, order items can be any goods ordered by a customer or other user. Order items are sometimes referred to as goods or just as items. However, order items can also be services.

### Example 5

### Exemplary Request for Delivery

In any of the examples herein, a request for delivery can take any form. That is, the delivery group management technologies described herein are not limited by the format of the request or the means by which the request is submitted. As one example, the request can be made by entering line items into a computer, such as via a website. However, other technologies can be used.

In general, a request for delivery of order items includes information sufficient to identify the requested items. However, additional information can be included, such as quantity, ship-to location, etc. Fixed constraints as described herein can be included in or with the request.

Although requests for delivery are sometimes described in the context of delivery of goods, technologies described herein can also be used in conjunction with requests for delivery of services. Thus, a request for delivery can be a sales order, service order, or stock transfer order, for example. Requests for delivery are sometimes referred to as orders.

An individual placing a request for delivery can be referred to as a requester, customer or user.

### Example 6

### Exemplary Sourcing Determination

In any of the examples herein, a sourcing determination is a determination of sourcing information for an order item. A sourcing determination can include determining any sourcing possibilities. For example, a sourcing determination can include determining a ship-from location for an item and/or the means of transport from the ship-from location to the customer or requester. Alternatively, a sourcing determination can include determining an external supplier which will send the ordered items directly to the customer.

A sourcing determination can be performed by a sourcing determination tool described herein.

### Example 7

### Exemplary Sourcing Possibilities

In any of the examples herein, sourcing possibilities describe variations in the way an order item is sourced. The sourcing possibilities for an order item are based on the sourcing information for that order item and describe different possibilities for its sourcing. Sourcing information includes, but is not limited to, the following: ship-from location, external supplier location, means of transport, freight forwarders, external shipment versus internal shipment, etc. For example, an item can be able to be sourced from different locations (e.g., warehouse A, warehouse B etc.). An item can be able to be transported using different means (e.g., ship, railroad, airplane, truck, etc.). An item can be able to be transported using different freight forwarders (e.g., different companies can be hired to organize shipments, different carriers can be used to move the organized shipments, etc.). An item can be shipped by an external supplier directly from the supplier's warehouse. Each of these sourcing options can lead to different sourcing possibilities. That is, any combination of these different possibilities can describe a different sourcing possibility for a particular item. Each sourcing possibility influences the way the delivery is completed for the customer. For example, each sourcing possibility can result in a different delivery duration, delivery costs, and/or delivery capacity.

For example, a first sourcing possibility for an item can include a particular ship-from location and means of transport. A second sourcing possibility for the same item can include either a different ship-from location or a different means of transport or both. Therefore, each sourcing possibility for an item describes a different combination of sourcing information.

### Example 8

### Exemplary Availability or ATP Check

In any of the examples herein, an availability check (also referred to as an available-to-promise or ATP check) is a determination of the availability of an order item. The availability check can include determining when an item will be available to be delivered to a requester, and/or what quantity will be available to be shipped on a particular date. Such a determination may be based on several pieces of information including, but not limited to, the following: inventory information for the goods in a warehouse, planned availability of goods in a warehouse based on future demand and supply information (e.g. purchase orders, planning orders, productions order, or other requests for delivery reserving some quantity of the goods), time it will take to ship the goods to a customer, where the goods will come from (e.g. an internal location or an external supplier), where the goods will be delivered to, how the goods will be transported (e.g. by truck or ship or other means of transport), steps to prepare the goods for transport, distance between ship-from location and ship-to location (e.g., customer location or arrival point), etc. Some of this information may be determined through a sourcing determination. For example, an ATP check can be performed for each sourcing possibility determined through a sourcing determination.

An availability check can determine a date of availability, sometimes referred to as a confirmation date. The confirmation date is the date when a quantity of the order item can be delivered to the requester. The quantity can be referred to as a confirmed quantity. The confirmation date can depend on the sourcing possibility that is checked for availability. The confirmation date for an item may be changed based on the confirmation dates of other items in the same delivery group (e.g., so that all items in the same delivery group have the same confirmation date and can be physically delivered together).

An availability check can be performed by an ATP or availability check tool described herein.

### Example 9

### Exemplary Fixed Constraints

As described herein, fixed constraints are used for grouping of items into delivery groups. For example, fixed constraints can be used to generate an initial delivery group for the order items listed in a request for delivery. Typically, fixed constraints represent physical constraints and therefore place limits on which items can be physically delivered together or placed in the same delivery group.

Exemplary fixed constraints include requested delivery date, ship-to address, freight forwarder, requested source of supply, and delivery rule. However, other fixed constraints can be used. For example, a user can designate items to be excluded from grouping.

Some fixed constraints are optional and some are mandatory. For example, a ship-to address can be a mandatory fixed constraint. Requested delivery date can also be a mandatory fixed constraint. (Requested delivery date can be automatically designated by the system—e.g. as “today”—if a user refrains from specifying the requested delivery date). Freight forwarder, requested source of supply, and delivery rule can be optional fixed constraints. A user can specify one or more fixed constraints to be associated with a request for delivery, or with one or more order items in a request for delivery.

A requested date is the date that the requester indicates he or she would like to receive an order item. Delivery rules represent one or more constraints on delivery designated as a rule, and can include a variety of combinations of constraints. Exemplary delivery rules include: Single Delivery-Full Quantity (i.e., the full quantity of all order items in a delivery group must be available as part of a single delivery) or Single On-Time Delivery (i.e., the requested delivery date must be met, but the delivery may comprise less than the requested quantity).

Fixed constraints can refer to parameters that must be satisfied before an order or request for delivery can be complete. Also, fixed constraints can referred to parameters that must be satisfied by all order items in a delivery group. For example, if a freight forwarder is designated as a fixed constraint for a particular request, the delivery groups for that request may only include items that are assigned to be delivered by the designated freight forwarder. However, in some examples, fixed constraints can be more flexible. For example, partial satisfaction of a fixed constraint can be sufficient to complete an order (e.g., greater than 90% satisfaction). Alternatively, fixed constraints can be ranked or prioritized so that satisfaction of all constraints is not necessary.

### Example 10

### Exemplary Delivery Group

In any of the examples herein, a delivery group includes one or more order items that are capable (e.g., physically capable) of being delivered together. For example, the order items can fit together on the same truck and are available for delivery on the same date. A delivery group can include one or more order items that satisfy specified fixed constraints. For example, the order items can all have the same requested delivery date.

Each item within a delivery group is characterized by or assigned to the same sourcing possibility. For example, the items can be said to have a common source of supply (e.g., all items in the delivery group have been assigned the same ship-from location and freight forwarder). Additionally, each item within the delivery group is characterized by or assigned the same confirmation date. For example, the items can be said to have confirmation dates that are aligned, or to have a common confirmation date. The confirmation dates can be generated by an availability determination, or technologies described herein may change the date for some items in order to align dates with those of other items to form a delivery group.

An exemplary delivery group includes order items with the same ship-from location, able to be transported by the same means, and available to be delivered on the same date. Delivery groups can be combined to form delivery alternatives. For example, delivery groups containing different order items can be combined so that the delivery alternative provides for delivery of all items in a request for delivery.

### Example 11

### Exemplary Delivery Alternatives

In any of the examples herein, a delivery alternative includes one or more delivery groups and provides for delivery of all items in an order. A delivery alternative represents a possible complete delivery for an entire order.

Each delivery alternative describes delivery of the same order items. For example, for a group of two order items, a first delivery alternative can include delivering both order items together in a single delivery from the same source (e.g. from the same warehouse). This first delivery alternative includes one (i.e., a first) delivery group. For the same two order items, it may also be possible to group the items into two deliveries (i.e., two delivery groups)—either from two different sources or at two different times—thereby creating a second and a third delivery group. (Alternatively, the two order items could be delivered together in a single delivery, but from a source different from the first delivery group, thereby creating a second delivery group.)

For example, for two order items (i.e., Item 1 and Item 2) available from two different sources (i.e., Source A and Source B) on two different dates (i.e., Date1 and Date2), the following can represent the availability of these two items:
Item 1 available on Date1 from Source A
Item 1 available on Date1 from Source B
Item 2 available on Date2 from Source A
Item 2 available on Date 2 from Source B

In this example, Date1 is before Date2 (i.e., if the availability date of Item 1 is moved from Date1 to Date2, then the availability date is moved into the future). The following represents possible delivery groups for Item 1 and Item 2 based on this availability:
Delivery Group 1—Item 1 and Item 2 to be delivered together on Date2 from Source A (A has been moved to Date2 since Date2 is later than Date1)
Delivery Group 2—Item 1 and Item 2 to be delivered together on Date2 from Source B (A has been moved to Date2 since Date2 is later than Date1)
Delivery Group 3—Item 1 to be delivered on Date1 from Source A
Delivery Group 4—Item 2 to be delivery on Date2 from Source A
Delivery Group 5—Item 1 to be delivery on Date1 from Source B
Delivery Group 6—Item 2 to be delivery on Date2 from Source B

The following represent possible ways in which these six delivery groups can be combined into delivery alternatives so that each delivery alternative provides for delivery of both items:
Delivery Alternative 1—Delivery Group 1
Delivery Alternative 2—Delivery Group 2
Delivery Alternative 3—Delivery Groups 3 and 4
Delivery Alternative 4—Delivery Groups 5 and 6.

Although, in this example, each delivery group was only included in one delivery alternative, in other examples, one or more delivery groups are part of several delivery alternatives, or part of no delivery alternative.

### Example 12

### Exemplary Cost Function

As described herein, a cost function is a parameter that can be calculated for each delivery group to quantify certain specified differences between the delivery groups. A cost function can be helpful to a user for evaluating delivery alternatives. For example, each delivery alternative can have a cost function, and the user can select one of the alternatives based on its cost function. In general, the cost function can enable the user to make an educated choice between delivery alternatives. Thus, the cost function can be displayed to the user along with the delivery alternatives to facilitate selection. Alternatively, the cost function can be used to make an automatic selection of a delivery alternative without receiving a selection from the user (e.g., the delivery alternative with the lowest cost function can always be selected).

The cost function can represent a cost (or a relative cost) that would be incurred by the requester if delivery is completed using the delivery alternative (e.g., the costs incurred if the sourcing possibility (or possibilities) assigned to the delivery groups of that delivery alternative is used). For example, the cost function can take into account the shipping and/or warehousing costs that would be incurred by using the delivery groups. Thus, the cost function can represent a cost penalty. However, other parameters useful for evaluating a delivery group can be quantified and included in the cost function. For example, any delay from the requested delivery date and/or any reduction from the requested quantity can be incorporated into the cost function. Furthermore, the number of delivery groups can also be quantified and included in the cost function.

Cost functions can be calculated by a cost engine described herein.

### Example 13

### Exemplary Delivery Group Management System

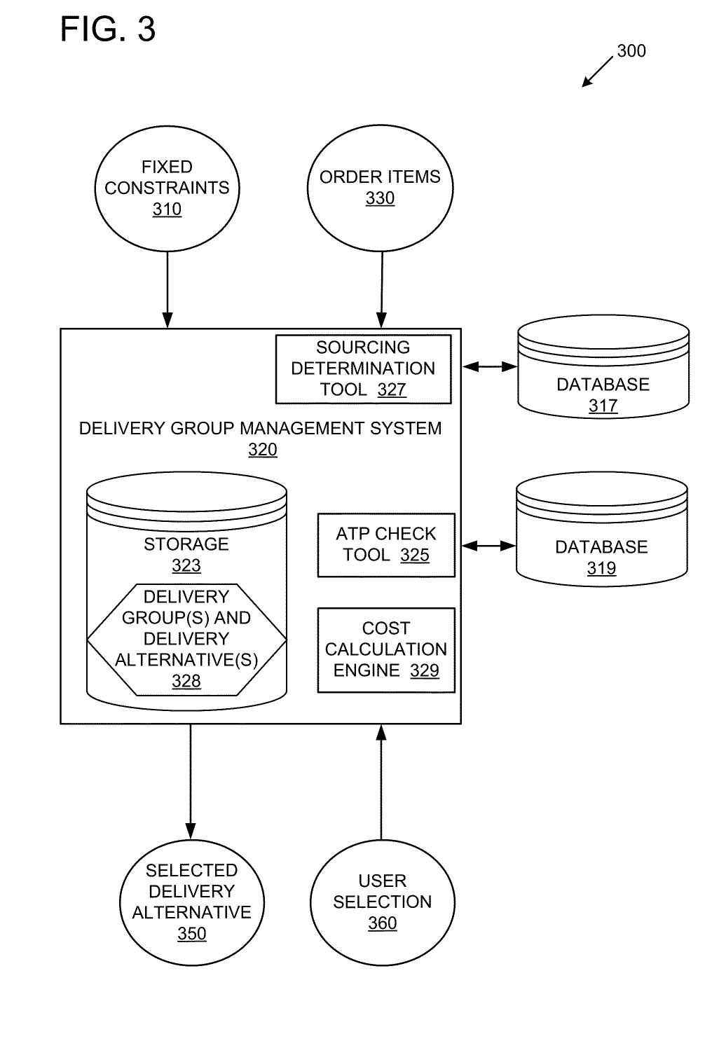

FIG. 3 is a block diagram of an exemplary system 300 implementing delivery group management technologies described herein. A delivery group management system 120 receives as input order items 330 and fixed constraints 310. The delivery group management system can include a sourcing determination tool 327, an availability check (e.g., available-to-promise (ATP) check) tool 325, and a cost calculation engine 329.

The sourcing determination tool 327 is configured to determine sourcing information, including sourcing possibilities, for the order items 330. The ATP check tool 325 is configured to check availability for the order items 330 using results from the sourcing determination tool 327. For example, the ATP check tool 325 can be configured to check availability for the order items 330 for multiple sourcing possibilities as determined by the tool 327.

The sourcing determination tool 327 can function by consulting a database 317. Likewise, the ATP check tool 325 can function by consulting a database 319. The databases 317, 319 can be integrated into the delivery group management system, or the databases can be part of one or more separate computers or computing environments. For example, communication with the database 317 and/or the database 319 can be via a network (e.g., the Internet).

The delivery group management system 320 is configured to use the fixed constraints 310 and the results from the ATP check tool 325 to build delivery group(s) and delivery alternative(s) 328. For example, the ATP check tool 325 can build delivery groups and combine the delivery groups into one or more delivery alternatives. The delivery groups and delivery alternatives 328 can be stored in storage 323. Additionally, the delivery group management system 320 can be configured to present the delivery groups and/or delivery alternatives 328 for display to a user. For example, the delivery group management system 320 can be configured to generate a user interface to display the delivery groups and/or delivery alternatives 328. The delivery group management system 320 can receive as input a user selection 360. For example, the user can make the selection 360 via the user interface displaying the delivery groups and/or delivery alternatives 328. Responsive to the user selection 360, the delivery group management system 320 can output the selected delivery alternative 350, which includes one or more of the delivery groups. For example, the delivery group management system 320 can be configured to present the selected delivery alternative 350 and/or its delivery groups for display.

Optionally, the delivery group management system 320 includes a cost calculation engine 329. The engine 329 is configured to calculate cost functions as described herein for the delivery alternatives 328. The delivery group management system 320 can be configured to provide the calculated cost functions for display with the delivery alternatives 328.

### Example 14

### Exemplary Network Implementing Delivery Group Management Technologies

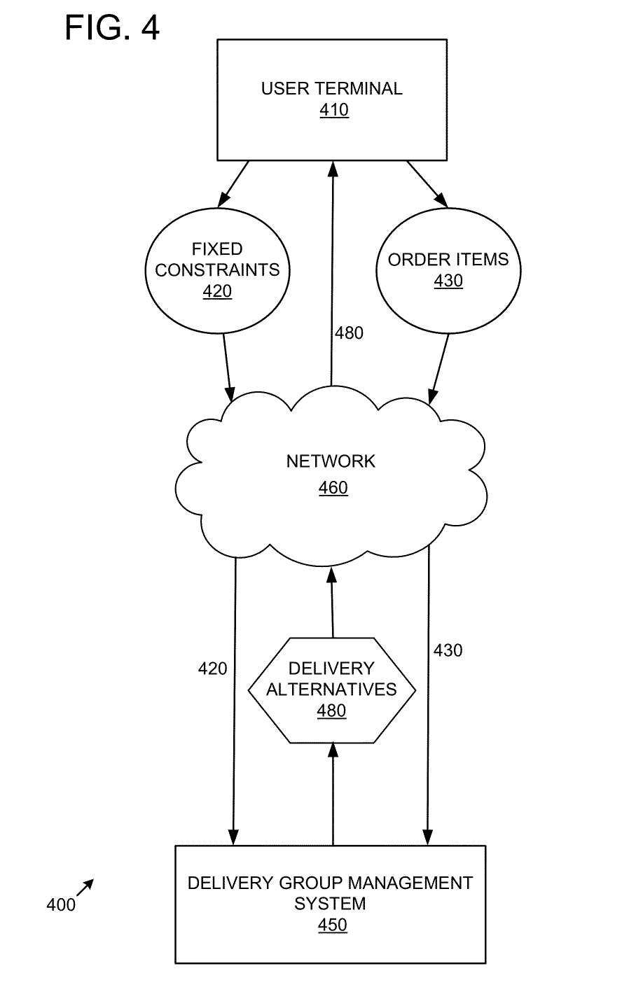

FIG. 4 is a block diagram of an exemplary system 400 implementing delivery group management technologies described herein using a network 460. In this example, a user terminal 410 is configured to transmit order items 430 and fixed constraints 420 via the network 460 to a delivery group management system 450. The delivery group management system 450 is configured to determine sourcing possibilities for the order items 430, to check availability of the order items 430 for the sourcing possibilities, to build delivery groups and delivery alternatives based on the sourcing and availability information as well as the fixed constraints 420. The delivery group management system 450 can be configured to transmit delivery alternatives 480 via the network 460 to the user terminal 410. The transmitted delivery alternatives 480 can also include the delivery groups that are combined to form the delivery alternatives 480. The user terminal 410 can be configured to display the delivery alternatives 480 to a user and to receive a user's selection of a delivery group.

### Example 15

### Exemplary Method of Building Delivery Alternatives

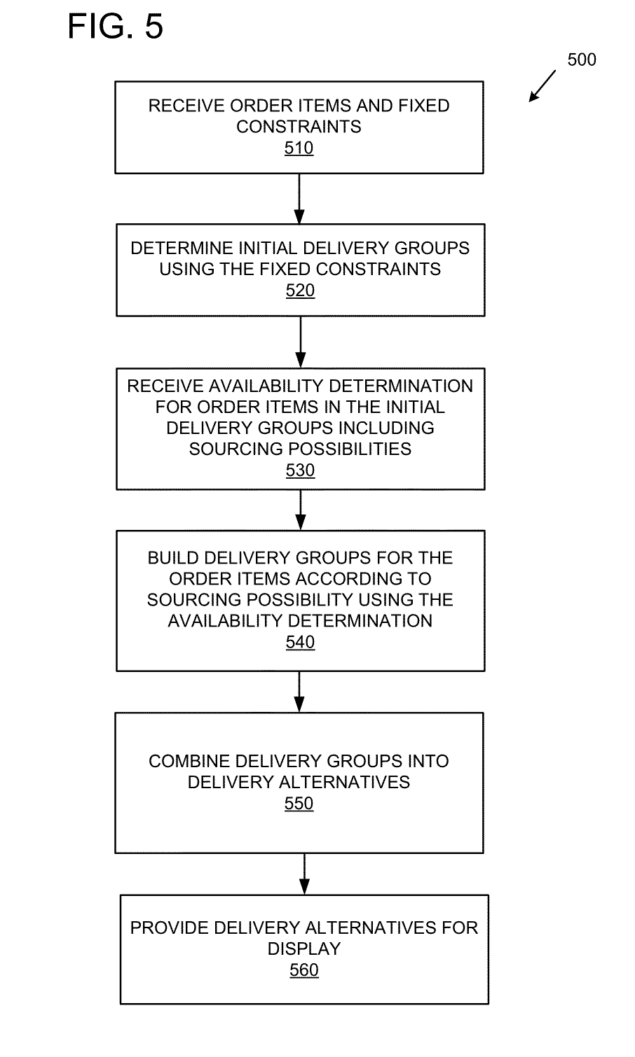

FIG. 5 is a flowchart of an exemplary method 500 of building delivery alternatives, and can be implemented, for example, in a delivery group management system described herein.

At 510, order items and fixed constraints are received. At 520, initial delivery groups are determined using the fixed constraints. The initial delivery groups include order items satisfying the fixed constraints. For example, if requested delivery date is a fixed constraint, all order items placed in the initial delivery group have the same requested date. If the received order items have different requested dates, then more than one initial delivery group can be created, where each initial delivery group contains order items having the same requested date.

At 530, an availability determination for the order items in the initial delivery groups is received, including sourcing possibilities. For example, the availability determination can be performed for each of the order items in each of the initial delivery groups. For example, the availability determination can include availability determinations for each sourcing possibility, or for multiple sourcing possibilities, for each of the order items (e.g., if an order item has more than one sourcing possibility, availability can be determined for each sourcing possibility for that item or for more than one of the sourcing possibilities for that item). Availability determinations can be received from an availability check tool described herein.

At 540, the order items in the initial delivery group are combined into delivery groups according to sourcing possibility using the results from the availability determination. For example, the order items included in each delivery group can be determined so that each delivery group includes only items having, or assigned to, the same sourcing possibility. For example, the order items in each delivery group can be shipped or delivered together as one shipment or delivery. Additionally, the order items included in each delivery group can be determined so that each delivery group includes only items having the same availability. For example, the order items in each delivery group can have, or be assigned to, the same delivery confirmation date. The delivery groups generated at 540 can be referred to as alternative delivery groups for the items in the initial delivery group.

At 550, the delivery groups are combined into delivery alternatives. For example, each delivery alternative can represent an option for delivering all the received order items (e.g., the entire order or request). At 560, the delivery groups are provided for display to a user.

### Example 16

### Exemplary Method of Determining Availability

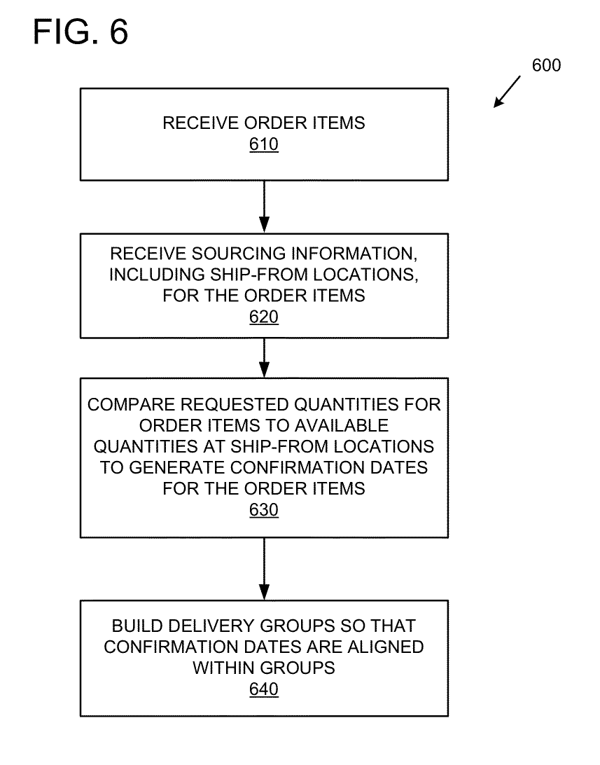

FIG. 6 is a flowchart of an exemplary method 600 of determining availability using sourcing information, and can be implemented, for example, in an availability check tool described herein.

At 610, order items are received. At 620, sourcing information for the order items, including ship-from locations, are received. For example, the sourcing information can be received from a source determination tool described herein. The sourcing information can include one or more sourcing possibilities for the received order items. At 630, requested quantities for the order items are compared to available quantities at ship-from locations to generate confirmation dates for the order items. Available quantities are quantities that are available to promise to the requester, and are usually based on several variables. For example, stocked quantities, planned quantities, reserved quantities from other orders, as well as other variables, can all affect the quantities that are available to promise to the requester. If an order item has more than one ship-from location or external supplier (e.g., more than one sourcing possibility), the comparison can be made for each, or for more than one, of the ship-from locations. The comparison can include determining whether some or all of the requested quantity can be satisfied by the ship-from location.

The confirmation dates represent a confirmed date when some or all of the requested quantity of the order item can be delivered. The confirmation date can be determined based on the available quantities as well as other sourcing information. For example, the confirmation date can depend on the distance between a ship-from and ship-to location, as well as means for transport between these two locations.

At 640, delivery groups are built so that the confirmation dates are aligned within the groups. For example, order items with the same confirmation date can be combined into delivery groups. Confirmation dates can also be changed so that all items in a delivery group have the same confirmation date. The delivery groups can then be combined into delivery alternatives.

### Example 17

### Exemplary Method of Implementing Delivery Group Management Technologies

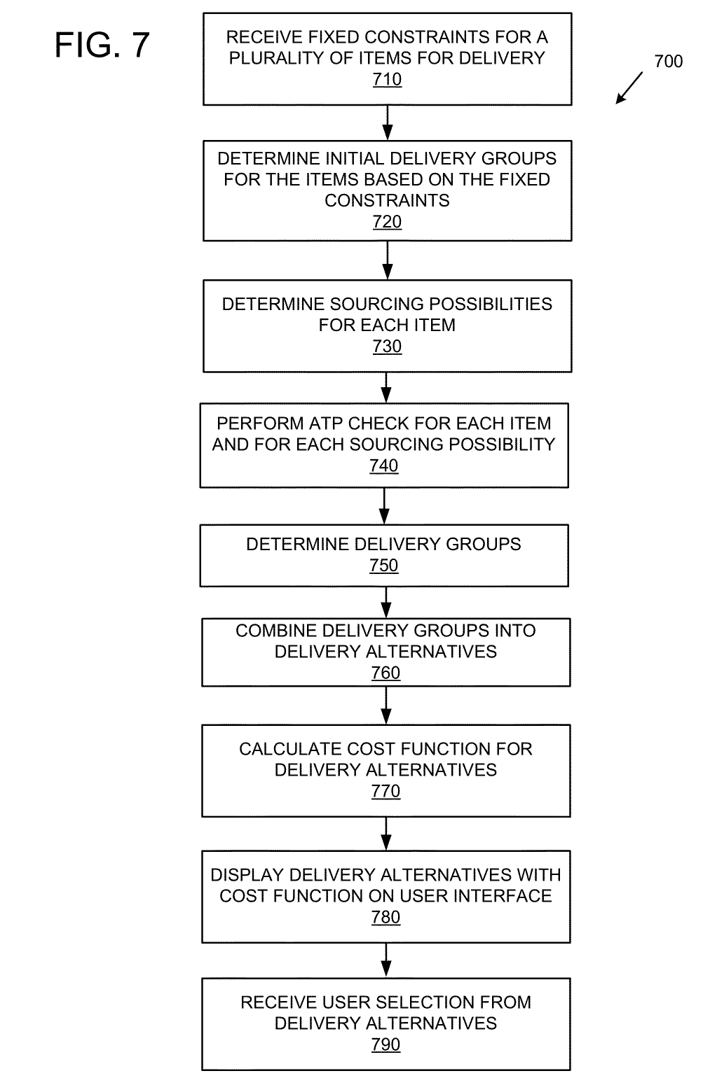

FIG. 7 is a flowchart of an exemplary method 700 implementing the delivery group management technologies described herein. At 710, fixed constraints for a plurality of items for delivery are received. At 720, initial delivery groups are determined for the items based on the fixed constraints. For example, initial delivery groups can be determined so as to include only items satisfying fixed constraints designated for those items.

At 730, sourcing possibilities for each item are determined. At 740, an ATP check is performed for each item and for each sourcing possibility for each item. At 750, delivery groups are determined based on the result of the ATP check. For example, the initial delivery groups can be split into smaller delivery groups, containing fewer order items. Alternatively, some of the initial delivery groups may not need to be split. At 760, delivery groups are combined into delivery alternatives. For example, one or more delivery groups can be combined to form each delivery alternative. In some examples, the initial delivery can be one of the delivery alternatives. At 770, cost functions are optionally calculated for the delivery alternatives. For example, a cost function can be calculated for each delivery alternative. At 780, the delivery alternatives can be displayed with cost functions on a user interface. At 790, a user selection from the displayed alternative delivery groups can be received.

### Example 18

### Exemplary User Interface Including a Request for Delivery

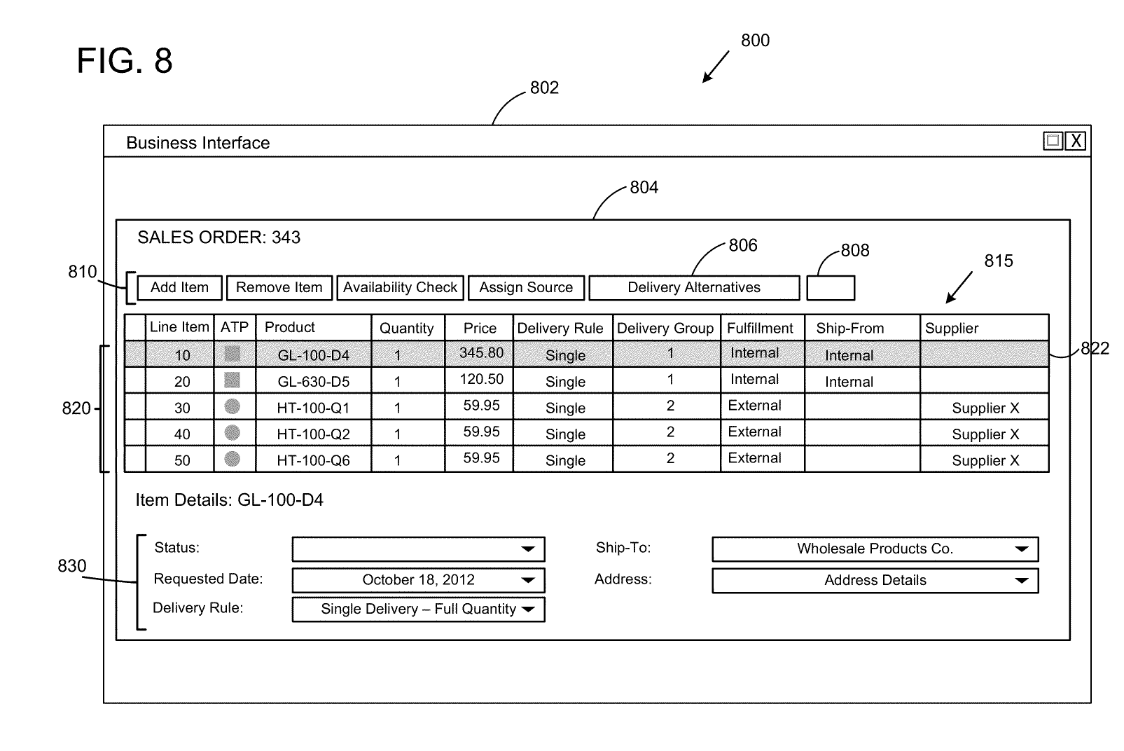

FIG. 8 is an exemplary user interface 800 for viewing and/or inputting a request for delivery 804 of order items 820. The request for delivery (or sales order) 804 can be presented as part of another user interface or window, such as the business interface window 802. The window 802 can be part of conventional business management software. The interface 800 can be presented to an order requester, such as via a user terminal or other computing environment.

The sales order 804 includes five order items 820 corresponding to five rows in a table 815. The order items 820 are displayed with various descriptive parameters listed in columns of the table 815. The information in the table 815 can be uploaded or input by the customer/requester. Although FIG. 8 includes particular descriptive parameters in the table 815, the table 815 is highly customizable, such that more or fewer parameters can be included. In general, the descriptive parameters are informative, and either describe the order items 820 or provide constraints for the items 820. Typically, the parameters in the table 815 can be modified by the requester. For example, FIG. 8 illustrates that selection of row 822 causes details 830 for that item (line item 10) to be displayed below the table 815. These details 830 can permit a requester to modify the descriptive parameters in the table 815, as well as other parameters not shown in the table 815, for the selected order item. For example, the requester can modify or input fixed constraints such as requested date, delivery rule, and ship-to address.

The sales order 804 is shown with several buttons 810 which can be used to add or remove items from the table 815, or to perform various functions on the order items 820 (e.g., to perform an availability check for one or more of the items). Although specific buttons 810 are shown in FIG. 8, more or fewer buttons can be included in the user interface 800.

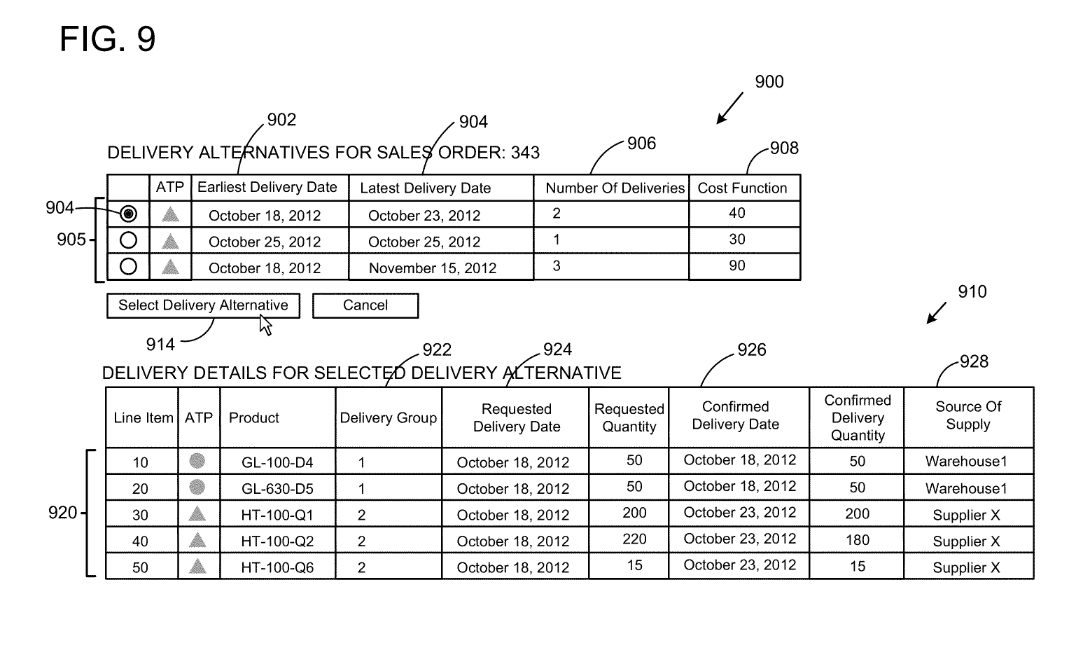

The sales order 804 also includes a Delivery Alternatives button 806. Selection of button 806 causes delivery alternatives to be displayed. For example, the order items 820 can form an initial delivery group, and selection of button 806 can cause delivery alternatives for the order items 820 to be displayed (see, e.g., FIGS. 9-11).

### Example 19

### Exemplary User Interface Displaying Delivery Alternatives

FIG. 9 illustrates an exemplary user interface displaying delivery alternatives 905 for all of the order items received as part of the sales order 343.

Table 900 lists three delivery alternatives 905 in three rows. The table 900 includes various information in its columns describing each of the three delivery alternatives 905. For example, the table 900 indicates an earliest delivery date 902 and a latest delivery date 904 for each of the delivery alternatives 905. Also, the table 900 includes the number of deliveries 906 as well as cost functions 908 for each of the delivery alternatives 905. Although FIG. 9 illustrates specific information 902, 904, 906, 908 in the table 900, more or less information can be displayed. For example, another column could show the fulfillment percentage (e.g., the percentage of how much of the requested quantity can be fulfilled with this delivery alternative). Each delivery alternative provides for delivery of all order items in the sales order.

Table 910 lists delivery details for order items 920 for a selected delivery alternative 904. For example, a user can click or otherwise select the delivery alternative in row 904 of table 900. Responsive to the selection, the details 910 can be displayed to the user. The table 910 can be displayed as part of the same user interface as table 900, or separately, such as part of a pop-up window. The table 910 can be used by the user to make an informed decision about which of the delivery alternatives 905 best suits his or her needs or his or her company policy.

The selected delivery alternative 904 includes two delivery groups (i.e., the number of deliveries listed in column 906 is two), as shown in column 922. In other words, the items 920 are split into two separate shipments or deliveries. Each delivery group is assigned a different sourcing possibility. That is, in this example, each delivery group has a different ship-from location (or source of supply) 928. Specifically, items 10 and 20 are assigned to the first delivery group 922 and to Warehouse1 920, while items 30, 40 and 50 are assigned to the second delivery group 922 and to Supplier X 920.

The confirmed delivery date 926 is provided based on availability determinations for the sourcing possibilities assigned to the order items 920. Confirmed dates are shown to be aligned (i.e., equal) within each delivery group 922.

The button 914 can be used to submit a user selection of a delivery alternative. The selected alternative can then be displayed, such as part of the user interface 800 of FIG. 8.

### Example 20

### Exemplary User Interface Displaying Delivery Alternatives

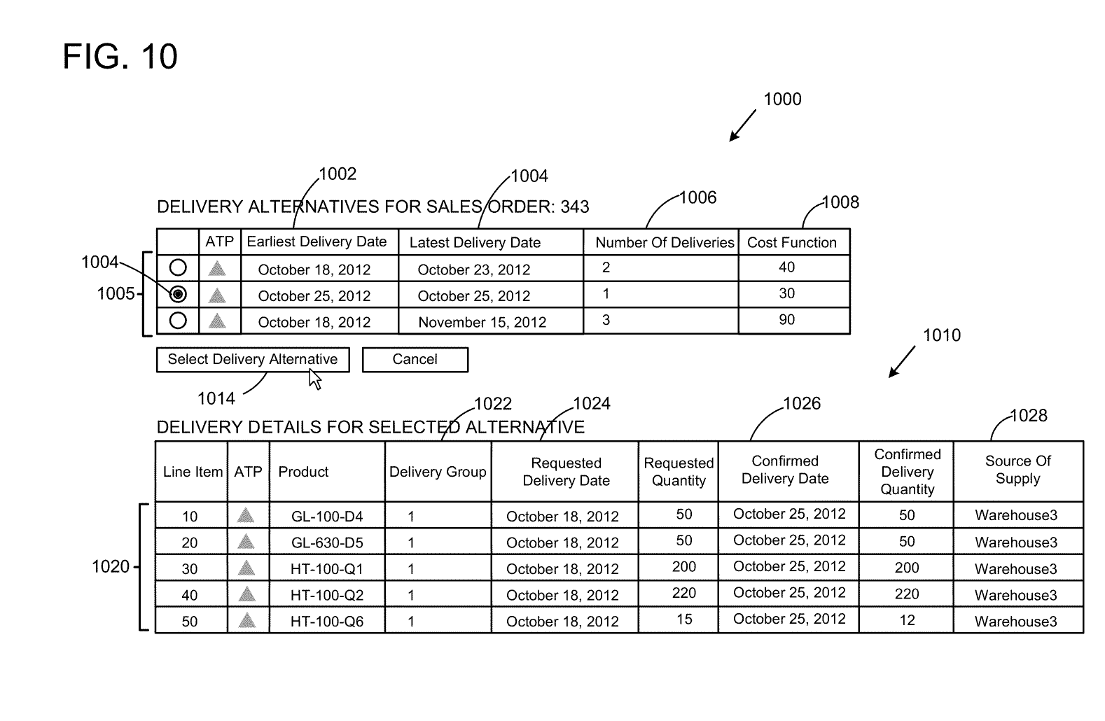

FIG. 10 illustrates an exemplary user interface displaying delivery alternatives 1005 for all of the order items received as part of the sales order 343.

Table 1000 lists three delivery alternatives 1005 in three rows. The table 1000 includes an earliest delivery date 1002, a latest delivery date 1004, number of deliveries 1006, and cost functions 1008 for each of the three delivery alternatives 1005. Although FIG. 10 illustrates specific information 1002, 1004, 1006, 1008 in the table 1000, more or less information can be displayed.

Table 1010 lists delivery details for the order items 1020 for a selected delivery alternative 1004. For example, a user can click or otherwise select the delivery alternative in row 1004 of table 1000. Responsive to the selection, the details 1010 can be displayed to the user. The selected delivery alternative 1004 includes one delivery group (i.e., the number of deliveries 1006 is one), as shown in column 1022. In other words, the items 1020 are to be delivered in the same shipment or delivery. Each item 1020 in the delivery group is assigned the same sourcing possibility. That is, in this example, each delivery group has the same ship-from location (or source of supply) 1028. Specifically, items 10, 20, 30, 40 and 50 are all assigned to Warehouse3 1028.

The confirmed delivery date 1026 is provided based on availability determinations for each of the order items 1020 for the sourcing possibility assigned to the order items 1020. Confirmed dates are shown to be aligned (i.e., equal) within the delivery group 1022.

The button 1014 can be used to submit a user selection of a delivery alternative. The selected alternative can then be displayed, such as part of the user interface 800 of FIG. 8.

### Example 21

### Exemplary User Interface Displaying Delivery Alternatives

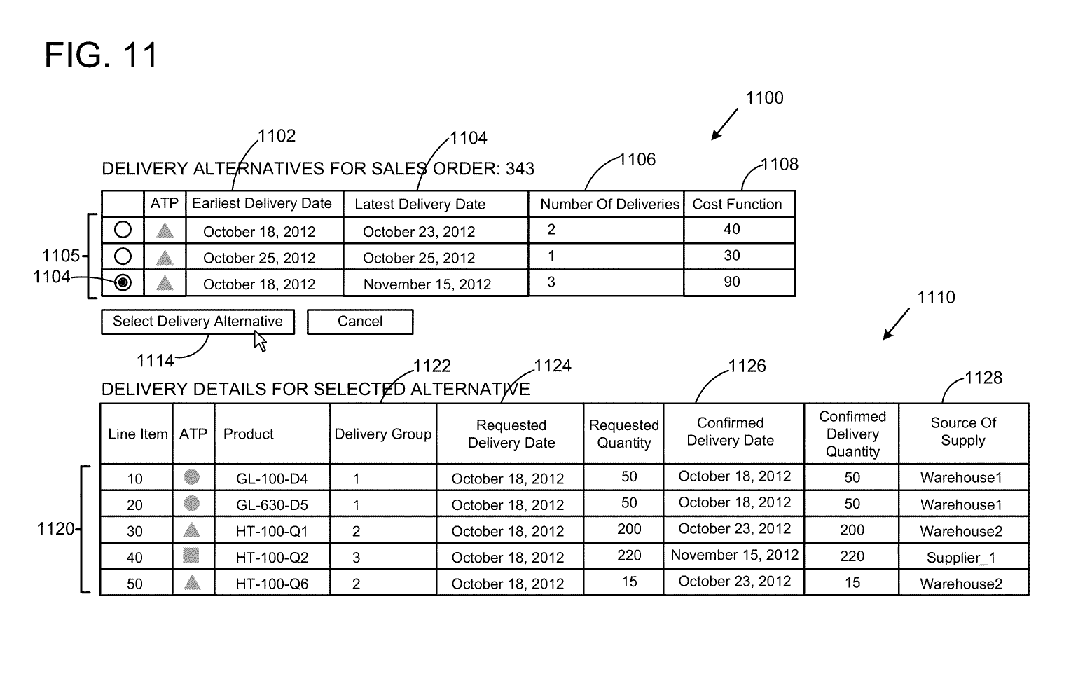

FIG. 11 illustrates an exemplary user interface displaying delivery alternatives 1105 for all of the order items received as part of the sales order 343.

Table 1100 lists three delivery alternatives 1105 in three rows. The table 1100 includes an earliest delivery date 1102, a latest delivery date 1104, a number of deliveries 1106, and cost functions 1108 for each of the three delivery alternatives 1105. Although FIG. 11 illustrates specific information 1102, 1104, 1106, 1108 in the table 1100, more or less information can be displayed.

Table 1110 lists delivery details for the order items 1120 for a selected delivery alternative 1104. For example, a user can click or otherwise select the delivery alternative in row 1104 of table 1100. Responsive to the selection, the details 1110 can be displayed to the user.

The selected delivery alternative 1104 includes three delivery groups (i.e., the number of deliveries 1106 is three), as shown in column 1122. In other words, the items 1120 are split into three separate shipments or deliveries. Each delivery group is assigned a different sourcing possibility and/or confirmation date. That is, in this example, each delivery group has a different ship-from location (or source of supply) 1120 or confirmed delivery date 1126. Specifically, items 10 and 20 are assigned to the first delivery group 1122, to Warehouse1 1128, and have a confirmed delivery date 1126 of Oct. 18, 2012. Items 30 and 50 are assigned to the second delivery group 1122, to Warehouse2 1128 and have a confirmed delivery date 1126 of Oct. 23, 2012. Item 40 is assigned to the third delivery group 1122, to Supplier_{—}1 1128, and has a confirmed delivery date 1126 of Nov. 15, 2012.

The confirmed delivery date 1126 is provided based on availability determinations for the sourcing possibilities assigned to the order items 1120. Confirmed dates are shown to be aligned (i.e., equal) within each delivery group 1122.

The button 1114 can be used to submit a user selection of a delivery alternative. The selected alternative can then be displayed, such as part of the user interface 800 of FIG. 8.

### Example 22

### Exemplary Order Completion

In any of the examples herein, delivery alternatives can be selected by a user or by a delivery management system described herein, such as according to a cost function. Selection can be performed via a user interface such as those illustrated in FIGS. 10 to 12, and can be performed by a user or based on user input. Once a delivery alternative is selected the delivery management system can complete the order, or the delivery management system can transmit the selected delivery alternative to another module or system, which completes the order.

Order completion includes scheduling the requested deliveries according to the selected delivery alternative. That is, an order for delivery is placed with the sourcing possibility of the selected delivery alternative for each of the items. For example, a request or other message can be transmitted to the sourcing location to confirm delivery of order items according to the conditions specified in the selected delivery alternative. The request can include the selected delivery alternative or information relating to the selected delivery alternative. For example, the request can include information sufficient to identify the order items requested and sufficient to specify how, when, and where the order items are to be delivered. This information is based on the sourcing possibility for each item for the selected delivery alternative.

For example, referring to FIG. 9, completing the order according to the selected delivery alternative 904 includes requesting deliveries according to table 910. Specifically, delivery of quantity 50 of item 10 is requested from Warehouse1 for delivery on Oct. 18, 2012; delivery of quantity 50 of item 20 is requested from Warehouse1 for delivery on Oct. 18, 2012; delivery of quantity 200 of item 30 is requested from Supplier X for delivery on Oct. 23, 2012, delivery of quantity 180 of item 40 is requested from Supplier X for delivery on Oct. 23, 2012; and delivery of quantity 15 of item 50 is requested from Supplier X for delivery on Oct. 23, 2012. The requests for delivery can involve sending or transmitting a message to Warehouse1 and/or Supplier X.

### Example 23

### Exemplary Advantages

Examples described herein can have several advantages. For example, delivery group management technologies described herein can provide more flexibility than conventional techniques. For example, companies generally have their own distinct policies and priorities for organizing items into delivery groups. By providing the customer with delivery alternatives and information such as cost functions for evaluating differences between those alternatives, users have the freedom to apply their company's policies when selecting a delivery group from the alternatives. Furthermore, for embodiments in which the alternative is selected automatically based on the cost function (e.g., the lowest cost alternative is automatically selected), the system can facilitate selection of an optimal delivery alternative without requiring user input/selection.

Additionally, examples described herein can be user-friendly and simplify delivery group management. Often a user makes grouping decisions of order items based on little or no information. Alternatively, the user may be expected to create groupings based on overwhelmingly complicated data relating to sourcing and availability. In either of these scenarios, the user is unable to determine optimal grouping of the items into one or several deliveries. Technologies described herein simplify this process by using the sourcing and availability data to create alternative delivery groups. The user can also be informed as to cost or other disadvantages associated with the delivery groups so that an educated decision can be made as to the preferred delivery group.

### Example 24

### Exemplary Computing Systems

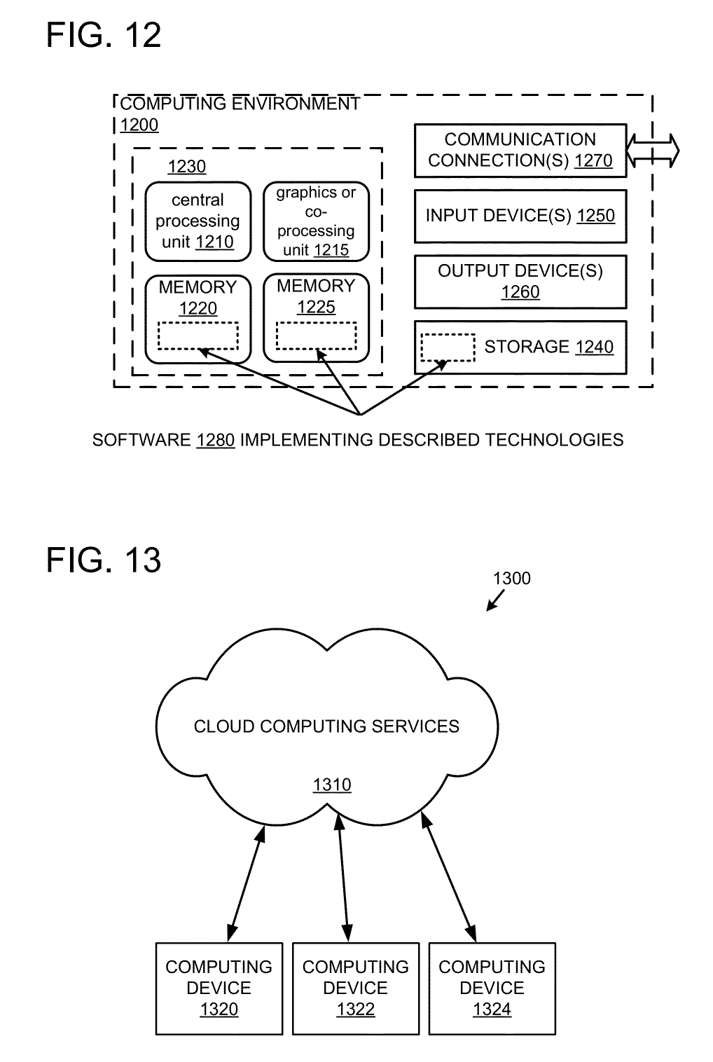

FIG. 12 depicts a generalized example of a suitable computing system 1200 in which the described innovations may be implemented. The computing system 1200 is Not intended to suggest any limitation as to scope of use or functionality, as the innovations may be implemented in diverse general-purpose or special-purpose computing systems.

With reference to FIG. 12, the computing system 1200 includes one or more processing units 1210, 1215 and memory 1220, 1225. In FIG. 12, this basic configuration 1230 is included within a dashed line. The processing units 1210, 1215 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 12 shows a central processing unit 1210 as well as a graphics processing unit or co-processing unit 1215. The tangible memory 1220, 1225 may be volatile memory (e.g., registers, cache, RAM), non-volatile memory (e.g., ROM, EEPROM, flash memory, etc.), or some combination of the two, accessible by the processing unit(s). The memory 1220, 1225 stores software 1280 implementing one or more innovations described herein, in the form of computer-executable instructions suitable for execution by the processing unit(s).

A computing system may have additional features. For example, the computing system 1200 includes storage 1240, one or more input devices 1250, one or more output devices 1260, and one or more communication connections 1270. An interconnection mechanism (not shown) such as a bus, controller, or network interconnects the components of the computing system 1200. Typically, operating system software (not shown) provides an operating environment for other software executing in the computing system 1200, and coordinates activities of the components of the computing system 1200.

The tangible storage 1240 may be removable or non-removable, and includes magnetic disks, magnetic tapes or cassettes, CD-ROMs, DVDs, or any other medium which can be used to store information in a non-transitory way and which can be accessed within the computing system 1200. The storage 1240 stores instructions for the software 1280 implementing one or more innovations described herein.

The input device(s) 1250 may be a touch input device such as a keyboard, mouse, pen, or trackball, a voice input device, a scanning device, or another device that provides input to the computing system 1200. For video encoding, the input device(s) 1250 may be a camera, video card, TV tuner card, or similar device that accepts video input in analog or digital form, or a CD-ROM or CD-RW that reads video samples into the computing system 1200. The output device(s) 1260 may be a display, printer, speaker, CD-writer, or another device that provides output from the computing system 1200.

The communication connection(s) 1270 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 25

### Exemplary Cloud Computing Environment

FIG. 13 depicts an example cloud computing environment 1300 in which the described technologies can be implemented. The cloud computing environment 1300 comprises cloud computing services 1310. The cloud computing services 1310 can comprise various types of cloud computing resources, such as computer servers, data storage repositories, networking resources, etc. The cloud computing services 1310 can be centrally located (e.g., provided by a data center of a business or organization) or distributed (e.g., provided by various computing resources located at different locations, such as different data centers and/or located in different cities or countries).

The cloud computing services 1310 are utilized by various types of computing devices (e.g., client computing devices), such as computing devices 1320, 1322, and 1324. For example, the computing devices (e.g., 1320, 1322, and 1324) can be computers (e.g., desktop or laptop computers), mobile devices (e.g., tablet computers or smart phones), or other types of computing devices. For example, the computing devices (e.g., 1320, 1322, and 1324) can utilize the cloud computing services 1310 to perform computing operators (e.g., data processing, data storage, and the like).

### Example 26

### Exemplary Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., non-transitory computer-readable media, such as one or more optical media discs such as DVD or CD, volatile memory components (such as DRAM or SRAM), or nonvolatile memory components (such as flash memory or hard drives)). By way of example and with reference to FIG. 12, computer-readable storage media include memory 1220 and 1225, and storage 1240. As should be readily understood, the term computer-readable storage media does not include communication connections (e.g., 1270) such as modulated data signals.

Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and non-obvious features and aspects of the various disclosed embodiments, alone and in various combinations and sub-combinations with one another. The disclosed methods, devices, and systems are not limited to any specific aspect or feature or combination thereof, nor do the disclosed embodiments require that any one or more specific advantages be present or problems be solved.

### ALTERNATIVES AND VARIATIONS

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope of these claims.

We claim:

1. A method, implemented at least in part by one or more computing devices, for determining delivery groups, the method comprising:
receiving a request for delivery of one or more order items, wherein at least one of the one or more order items has a plurality of sourcing possibilities;
receiving one or more fixed constraints for the delivery of the one or more order items;
determining availability of the one or more order items including the plurality of sourcing possibilities;
building delivery groups for the one or more order items based on the availability determination and the fixed constraints;
combining the delivery groups into delivery alternatives for the one or more order items; and
providing the delivery alternatives for display to a user.

2. The method of claim 1, wherein the plurality of sourcing possibilities of the one or more order items includes a plurality of sourcing locations and the determining of availability comprises:
comparing a requested quantity of the one or more order items to available quantities at the plurality of sourcing locations, wherein the comparing comprises generating confirmation dates for the one or more order items, wherein the building of delivery groups is performed so that the confirmation dates are aligned within the delivery groups.

3. The method of claim 2, further comprising:
determining the plurality of sourcing possibilities for the at least one of the one or more order items, including determining the sourcing locations for the at least one of the one or more order items.

4. The method of claim 1, further comprising:
determining initial delivery group for the request based on the one or more fixed constraints, wherein the building of the delivery groups comprises splitting the initial delivery groups into two or more delivery groups containing fewer order items than the initial delivery groups.

5. The method of claim 4, wherein the fixed constraints include requested delivery date and the initial delivery group includes only order items having the same requested delivery date.

6. The method of claim 4, wherein the fixed constraints include ship-to address and the initial delivery group includes only order items having the same ship-to address.

7. The method of claim 1, further comprising:
calculating cost functions for the delivery alternatives.

8. The method of claim 1, further comprising:
receiving a selection of a delivery alternative; and
scheduling delivery of the one or more order items in accordance with the selected delivery alternative, wherein the scheduling includes placing an order for delivery with a sourcing possibility of the selected delivery alternative.

9. The method of claim 1, further comprising:
determining sourcing locations for the at least one of the one or more order items, wherein the determining the availability of the one or more order items comprises determining the availability of the at least one of the one or more order items for each of the sourcing locations.

10. The method of claim 1, wherein the combining of the delivery groups into delivery alternatives comprises:
assigning delivery groups to delivery alternatives so that each delivery alternative provides for delivery of the one or more order items.

11. The method of claim 1, wherein the building of delivery groups comprises:
building an initial delivery group including the one or more order items using the one or more fixed constraints;
building the delivery groups from the initial delivery group by assigning order items to the delivery groups based on the availability determination and sourcing possibilities of the one or more order items; and
aligning confirmation dates for the order items in the delivery groups.

12. The method of claim 1, wherein the delivery groups satisfy the fixed constraints.

13. The method of claim 1, wherein the building of delivery groups comprises:
grouping the one or more order items into the delivery groups according to the plurality of the sourcing possibilities such that order items within delivery groups are assigned a same sourcing possibility.

14. The method of claim 1, wherein order items within the delivery groups have a same confirmed delivery date selected based on results of the availability determination.

15. One or more computer-readable storage media storing computer-executable instructions for causing a computing device to perform a method comprising:
receiving a request for delivery of one or more order items, wherein at least one of the one or more order items has a plurality of sourcing possibilities;
receiving one or more fixed constraints for the delivery of the one or more order items;
determining availability of the one or more order items including the plurality of sourcing possibilities;
building delivery groups for the one or more order items based on the availability determination and the fixed constraints; and
combining the delivery groups into delivery alternatives for the one or more order items.

16. The one or more computer-readable storage media of claim 15, wherein the method further comprises:
determining an initial delivery group for the request based on the one or more fixed constraints, wherein the building of the delivery groups comprises splitting the initial delivery group into two or more delivery groups containing fewer order items than the initial delivery group.

17. The method of claim 15, further comprising:
determining sourcing locations for the at least one of the one or more order items, wherein the determining the availability of the one or more order items comprises determining the availability of the at least one of the one or more order items for each of the sourcing locations.

18. The method of claim 17, wherein the combining of the delivery groups into delivery alternatives comprises:
assigning delivery groups to delivery alternatives so that each delivery alternative provides for delivery of the one or more order items.

19. A computer system, comprising:
a processor;
memory; and
a delivery group management system configured to receive requests for delivery of order items and one or more fixed constraints for the order items, the delivery group management system comprising:
a source determination tool configured to determine sourcing possibilities for the received order items;
an availability check tool configured to determine availability of the received order items using the determined sourcing possibilities; and
a delivery group building tool configured to build delivery groups based on the one or more fixed constraints and to combine the delivery groups into delivery alternatives using results from the availability check tool, wherein the delivery group management system is further configured to provide the delivery alternatives for display as part of a user interface and to receive a user selection of a delivery alternative from the displayed delivery alternatives.

20. The computer system of claim 19, wherein the delivery group management system further comprises:
a cost engine configured to calculate cost functions for the delivery alternatives, wherein the delivery group management system is further configured to provide the calculated cost functions for display with the delivery alternatives as part of the user interface.
